(19) United States
(12) Patent Application Publication
(10) Pub. No.: US 2024/0326387 A1
(43) Pub. Date: Oct. 3, 2024

(54) HEATABLE VEHICLE GLAZING

(71) Applicant: SAINT-GOBAIN GLASS FRANCE, Courbevoie (FR)

(72) Inventors: Christoph KIRCH, Herzogenrath (DE); Dirk VICTOR, Herzogenrath (DE)

(21) Appl. No.: 18/575,931

(22) PCT Filed: Jul. 18, 2022
(86) PCT No.: PCT/EP2022/070003

§ 371 Date: Jan. 2, 2024

(30) Foreign Application Priority Data
Aug. 10, 2021 (DE) 10 2021 120 804.1

(51) Int. Cl. B32B 17/10; H05B 3/84

(52) U.S. Cl. CPC B32B 17/10385; B32B 17/10036; B32B 17/10229; B32B 17/10651; B32B 17/10761; B32B 17/10807; H05B 3/84

(57) ABSTRACT

A vehicle glazing having a first pane and a second pane connected via a thermoplastic intermediate layer. The second pane has an electrically conductive functional layer arranged on an internal surface of the second pane facing the thermoplastic intermediate layer. A first area of the second pane is a test area with a central field of vision, and a second area of the second pane is a roof area with a curvature, and the second area is electrically heatable. The second area has a heating element with two bus bars and at least a portion of the electrically conductive functional layer such that a current flows through the electrically conductive functional layer when an electrical voltage is applied to the bus bars. The first area is electrically insulted from the second area by a third area.

The invention relates to a vehicle glazing, in particular a panoramic pane, to a method for producing the vehicle glazing and to the use thereof.

New production methods allow the production of glazings with complex shaping and equally large dimensions. Windscreens in the automotive sector are an example of complex shaping. A windscreen extended into the roof area of a vehicle is referred to as a so-called panoramic windscreen. Such a windscreen enables the occupants of the vehicle to freely gaze upward and thus imparts a new driving experience.

Glazings are increasingly provided with large-area, electrically conductive layers that are transparent to visible light. These layers are metal-based and are referred to as functional layers. For example, for reasons of energy-saving and comfort, high demands are placed on vehicle panes with respect to their thermal insulation properties. It is known to equip vehicle panes with transparent, electrically conductive coatings having IR-reflective properties. In this case, a distinction can be made between sun protection coatings and emissivity-reducing coatings (low-e coatings). Sun protection coatings reflect portions of the solar radiation in the near-infrared spectrum and prevent them from heating the vehicle interior. They typically have one or more silver layers.

In contrast, emissivity-reducing coatings (so-called low-e coatings) reflect radiation in a farther IR range, in particular the thermal radiation emitted by a heated glass pane. The penetration of thermal radiation into the vehicle interior is reduced, which also causes low heating of the interior. In winter, when the outside temperature is low, the heat of the interior is prevented from radiating to the outside environment. Emissivity-reducing coatings may contain, for example, reflective layers based on indium tin oxide (ITO) or other transparent conducting oxides (TCO), as known, for example, from WO 2013/131667A1. Without such a coating on the surface of a pane facing the vehicle interior, the pane can act as a heat sink. This is perceived as unpleasant by the occupants, in particular in the head area.

WO 2010/043598 A1 discloses a vehicle pane with an electric heating layer, which causes targeted heating of the vehicle pane by applying an electrical voltage.

DE 11 2018 006 248 T5 discloses a panoramic glass roof with a silver frit heating circuit.

The object of the present invention is to provide an improved vehicle glazing with an electrically conductive functional layer and a method for its production.

According to the invention, this object is achieved by a vehicle glazing according to claim 1. Preferred embodiments of the invention are apparent from the dependent claims. A production method and the use of the vehicle glazing become apparent from further claims.

The vehicle glazing according to the invention, in particular a panoramic pane, comprises at least a first pane and a second pane, which are connected to one another by a thermoplastic intermediate layer. The vehicle glazing has an electrically conductive functional layer, which is arranged on an internal surface of the second pane facing the thermoplastic intermediate layer, and a first area and an electrically heatable second area, wherein the first area is designed as a test area provided with a central field of vision of the vehicle glazing and the second area is designed as a roof area provided with a curvature. The second area is provided with a heating element, which comprises two bus bars and, at least in part, the electrically conductive functional layer such that, when an electrical voltage is applied to the bus bars, a current flows through the electrically conductive functional layer. Furthermore, the first area is separated from the second area by a third, electrically insulating area.

The vehicle glazing can be designed as a composite pane, in particular a windscreen, a panoramic windscreen or a panoramic rear pane. Within the meaning of the invention, a panoramic pane is a windscreen or rear pane, in which the second, upper area of the pane has been substantially extended such that it comprises a part of the vehicle roof. In particular, the second area of the windscreen or rear pane comprises a portion of the roof that is arranged over the front or rear seat area of a vehicle. In other words, such vehicle glazing offers the occupants an expanded vertical angle of view.

The invention is based, inter alia, on the idea of actively heating the vehicle glazing designed as a windscreen in the upper area, which in one installation position offers a visible area extending up into the roof area, in order to thus prevent cooling in the head area of the occupants sitting under the roof area.

A major advantage is that the intermediate space between the vehicle glazing and the heads of the occupants is quickly heated and a heat sink in the area of the vehicle glazing directly above the heads of the occupants is avoided. Furthermore, the second heatable area can be freed from fogging from moisture and kept free of fogging during winter operation or cold operation.

The second, heatable area can be arranged in the installation position in the upper sub-area of the vehicle glazing. That is to say, the second area in a vehicle glazing designed as a windscreen projects rearward in the longitudinal direction, in particular as seen in a longitudinal direction of the vehicle. In other words, the second area is arranged above the first area. In this case, the second area extends into the plane of the roof.

The second heatable area is arranged above the central field of vision (e.g. field of vision B). This means that the second area is arranged between the central field of vision and an upper edge of the vehicle glazing, in particular of a windscreen.

Preferably, the electrically conductive functional layer is transparent. For the purposes of the present invention, “transparent” means that the overall transmittance of the vehicle glazing complies with the legal requirements for windscreens and front side panes and preferably has a transmittance for visible light (in the spectral range from 380 nm to 780 nm) of more than 70% and, in particular, of more than 75%. For rear side panes and rear panes, “transparent” can also mean 15% to 70% light transmission. Accordingly, “opaque” means a light transmission of less than 15%, preferably less than 5%, in particular 0%.

In a preferred embodiment, in the installation position of the vehicle glazing, the bus bars extend substantially in the longitudinal direction of the vehicle and/or parallel to two opposite side edges of the vehicle glazing. This achieves a particularly homogeneous heat distribution.

The electrical contact of the electrically conductive functional layer to the electrical power supply takes place via the bus bars. The bus bars can be arranged in the shape of strips on two opposite sides of the electrically conductive functional layer. In particular, they can be designed as two strips extending approximately parallel.

The bus bars can have a width of 2 mm to 30 mm, particularly preferably of 4 mm to 20 mm. The length of a bus bar depends on the extent of the surface to be heated. The length of the bus bars is typically substantially equal to the length of the side edge of the electrically conductive functional layer in the second area of the vehicle glazing, but it can also be slightly smaller. In such bus bars, the longer of its dimensions is referred to as the length and the shorter of its dimensions is referred to as the width. More than two bus bars can also be arranged on the electrically conductive functional layer, preferably in the edge area along two opposite side edges of the electrically conductive functional layer.

The layer thickness of the printed bus bars is preferably 5 μm to 40 μm, particularly preferably 8 μm to 20 μm, and most preferably 8 μm to 12 μm. Printed bus bars with these thicknesses are technically simple to realise and have an advantageous current-carrying capacity. The specific resistivity pa of the bus bars is preferably 0.8 μOhm·cm to 7.0 μOhm·cm, and particularly preferably 1.0 μOhm·cm to 2.5 μOhm·cm. Bus bars with specific resistivities in this range are technically simple to realise and have an advantageous current-carrying capacity. This achieves good results.

In one embodiment of the invention, the printed bus bars preferably contain at least a metal, metal alloy, metal compound, and/or carbon, particularly preferably a noble metal, and in particular silver. The printing paste preferably contains metal particles and/or carbon, and in particular noble metal particles such as silver particles. The electrical conductivity is preferably achieved by the electrically conductive particles. The particles can be in an organic and/or inorganic matrix such as pastes or inks, and preferably as a printing paste with glass frits. Alternatively, a bus bar can however also be designed as a strip of an electrically conductive film. The bus bar then contains, for example, at least aluminium, copper, tinned copper, gold, silver, zinc, tungsten and/or tin, or alloys thereof. The strip preferably has a thickness of 10 μm to 500 μm, particularly preferably of 30 μm to 300 μm.

Bus bars made of electrically conductive films with these thicknesses are technically simple to realise and have an advantageous current-carrying capacity. The strip can be electrically conductively connected to the electrically conductive structure, for example via a soldering compound, via an electrically conductive adhesive or by direct placement. These materials and their thicknesses are particularly advantageous with regard to very good conductivity of the bus bars.

The bus bars are electrically contacted by one or more supply lines. The supply line is preferably designed as a flexible foil conductor (flat conductor, flat-ribbon conductor). The term “foil conductor” means an electrical conductor whose width is significantly greater than its thickness. Such a foil conductor is, for example, a strip or ribbon containing or consisting of copper, tinned copper, aluminium, silver, gold, or alloys thereof. The foil conductor has, for example, a width of 2 mm to 16 mm and a thickness of 0.03 mm to 0.1 mm. The foil conductor may have an insulating, preferably polymeric sheath, on the basis of polyimide, for example. Foil conductors that are suitable for contacting electrically conductive coatings in panes have a total thickness of, for example, only 0.3 mm. Such thin foil conductors can be embedded without difficulty in the thermoplastic intermediate layer between the individual panes. Multiple conductive layers electrically insulated from one another can be situated in a foil conductor strip.

Alternatively, thin metal wires can also be used as an electrical supply line. The metal wires contain in particular copper, tungsten, gold, silver, or aluminium or alloys of at least two of these metals. The alloys can also contain molybdenum, rhenium, osmium, iridium, palladium, or platinum.

In principle, the electrically conductive functional layer can be designed in any way. Preferably, it is a coating that is transparent to visible light and comprises at least one layer made of a metal. The functional layer is preferably applied to the pane over a large area.

The electrically conductive functional layer is arranged at least on the internal surface of the second pane and covers or overlaps the surface of the second pane completely or partially, but preferably over a large area. The term “large-area” means that at least 50% of the surface of the pane are covered by the functional layer. However, the functional layer can also extend over smaller portions of the surface of the pane.

The electrically conductive functional layer is a single layer or a layer structure consisting of a plurality of individual layers having a total thickness of, for example, less than or equal to 2 μm, preferably less than or equal to 1 μm. Advantageously, the electrically conductive, metal-based functional layer has a thickness of 80 nm to 1000 nm, in particular of 80 nm to 600 nm, preferably of 120 nm to 400 nm.

Preferably, the electrically conductive functional layer is a sun protection layer with reflective properties in the infrared range and thus in the range of solar radiation, whereby heating of the interior of a vehicle as a result of solar radiation is advantageously reduced. Functional layers having a sun protection effect typically contain at least one metal, in particular silver or a silver-containing alloy. The layer having sun protection effect can comprise a sequence of a plurality of individual layers, in particular at least one metallic layer and dielectric layers, which contain, for example, at least one metal oxide.

Preferably, the electrically conductive, metal-based functional layer contains at least one metal layer, for example of silver, nickel, chromium, niobium, tin, titanium, copper, palladium, zinc, gold, cadmium, aluminium, silicon, tungsten, or alloys thereof. The electrically conductive, metal-based functional layer preferably comprises a metal layer, such as a silver layer or layer made of a silver-containing metal alloy. Typical silver layers preferably have thicknesses of 5 nm to 18 nm, particularly preferably 8 nm to 15 nm. The metal layer can be sandwiched between at least two layers of dielectric material of the metal oxide type. The metal oxide preferably includes zinc oxide, tin oxide, indium oxide, titanium oxide, silicon oxide, aluminium oxide or the like, along with combinations of one or more thereof. The dielectric material preferably contains silicon nitride, silicon carbide, aluminium nitride, and combinations of one or more thereof. Such metal-based functional layers having a sun protection effect are known, for example, from WO 2007/101964 A1, WO2013/104439 A1 and DE69731268T2.

For example, the metal-based functional layer has a sheet resistance from 0.1 ohm/sq to 200 ohm/sq, more preferably from 1 ohm/sq to 50 ohm/sq and most preferably from 1 ohm/sq to 10 ohm/sq.

The thickness of an electrically conductive, metal-based functional layer having a sun protection effect can vary widely and can be adapted to the requirements of the individual case, wherein a layer thickness of 10 nm to 5 μm and, in particular, 30 nm to 1 μm is preferred.

Preferably, the electrically conductive functional layer acts as a sun protection coating in the first area of the vehicle glazing and as a heatable coating having at least one metallic layer, preferably having at least one, two or three silver layers, in the second area of the vehicle glazing.

In a further, preferred embodiment, the first area at least partially has the electrically conductive functional layer, wherein the first area is separated from the second area by the third, electrically insulating area. Preferably, the third, electrically insulating area has an insulation line, wherein the third area is free of electrically conductive material. Particularly preferably, the third area is arranged horizontally between two side edges of the vehicle glazing. The third, electrically insulating area can be very narrow compared to the first or second area. The width of the third area can be 5 μm to 500 μm, in particular 20 μm to 200 μm.

The electrically conductive functional layer is arranged on the internal surface of the second pane facing the thermoplastic intermediate layer. Also located on the internal surface of the second pane is a coating-free edge area, which is free of the electrically conductive functional layer and extends from a side edge of the first pane over at least 5 mm to at most 25 mm on the internal surface. No electrically conductive functional layer is arranged in this coating-free edge area. As a result, corrosion-induced degradation of the electrically conductive, metal-based functional layer can be significantly reduced.

The first pane, the second pane and the thermoplastic intermediate layer may be independently clear and colourless, tinted or coloured.

In a further preferred embodiment, the intermediate layer has at least partially a tinted or coloured area. In this case, the intermediate layer is preferably not tinted or coloured in the central field of vision of the vehicle glazing.

Windscreens in particular have a central field of vision, the optical quality of which is subject to high demands. The central field of vision has to have a high light transmission (typically greater than 70%). Said central field of vision is in particular the field of vision which is referred to by the person skilled in the art as field of vision B, test area B or zone B. The field of vision B and its technical requirements are defined in Regulation No. 43 of the United Nations Economic Commission for Europe (UN/ECE) (ECE-R43, “Uniform provisions concerning the approval of safety glazing materials and their installation on vehicles”). There, the field of vision B is defined in Annex 18.

The thermoplastic intermediate layer contains at least one thermoplastic polymer, preferably ethylene vinyl acetate (EVA), polyvinyl butyral (PVB) or polyurethane (PU) or mixtures or copolymers or derivatives thereof, particularly preferably PVB, most preferably polyvinyl butyral (PVB), and additives known to the person skilled in the art such as plasticisers. The intermediate layer is typically formed from a thermoplastic film. The thickness of the intermediate layer is preferably from 0.2 mm to 2 mm, particularly preferably from 0.3 mm to 1 mm.

The thermoplastic intermediate layer may be formed by a single film or also by more than one film. In order to improve the acoustically damping properties of a vehicle glazing, a three-layer thermoplastic intermediate layer comprising an acoustically damping layer arranged between two thermoplastic layers is preferably laminated between the two panes of the glazing. The acoustically damping layer is preferably thinner than 300 μm (microns). The thickness of the acoustically damping layer is in particular 70 μm to 130 μm, for example 100 μm.

A vehicle glazing according to the invention can additionally comprise a cover print, in particular of a dark, preferably black, enamel. The cover print is in particular a peripheral, i.e., frame-like, cover print. The peripheral cover print primarily serves as UV protection for the mounting adhesive of the vehicle glazing. The cover print can be opaque and designed to cover the entire surface. The cover print can also be designed to be semi-transparent at least in sections, for example as a dot matrix, stripe matrix, or checkered matrix. Alternatively, the cover print can also have a gradient, for example from an opaque coverage to a semi-transparent coverage. The cover print is usually applied to the interior-side surface of the pane that represents the outer pane in the installation position, or on the interior-side surface of the pane that represents the inner pane in the installation position.

The vehicle glazing is provided to separate the interior from the external environment in a window opening of a vehicle. For the purposes of the invention, the term “inner pane” refers to the pane of the vehicle pane facing the vehicle interior. Outer pane means the pane facing the external environment.

In a preferred embodiment of the motor vehicle pane, the first pane is the outer pane and the second pane is the inner pane of the vehicle.

In an advantageous embodiment, the first and/or second pane contains or consists of non-tempered, partially tempered or tempered glass, preferably flat glass, float glass, quartz glass, borosilicate glass, soda-lime glass. Alternatively, the panes contain or consist of clear plastics, preferably rigid clear plastics, particularly polyethylene, polypropylene, polycarbonate, polymethyl methacrylate, polystyrene, polyamide, polyester, polyvinyl chloride and/or mixtures thereof.

The invention further comprises a method for producing a vehicle glazing according to the invention having an electrically conductive functional layer, which comprises the following method steps:
providing a first pane and a second pane, each having a first area and a second area arranged above the first area,
applying an electrically conductive functional layer to the surface of the second pane intended to be an internal surface (III),
removing the electrically conductive functional layer to form a third, electrically insulating area separating the first area from the second area,
applying two bus bars within the second area, which electrically contact the electrically conductive functional layer at least partially such that a current flows through the electrically conductive functional layer when an electrical voltage is applied to the bus bars,
providing a thermoplastic intermediate layer having a tinted and/or coloured area which is at least as large as the second, upper area of the vehicle glazing,
forming a stack of the first pane, the second pane and the thermoplastic intermediate layer in between, such that the internal surface (III) of the second pane points toward the thermoplastic intermediate layer and the tinted and/or coloured area of the intermediate layer covers the second, upper area,
connecting the first pane, the second pane and the thermoplastic intermediate layer under the action of heat, vacuum and/or pressure.

The electrically conductive functional layer is preferably applied in a vacuum-based coating method. Suitable vacuum-based coating methods are, for example, CVD (chemical vapour deposition) or PVD (physical vapour deposition), preferably cathode sputtering (“sputtering”), particularly preferably magnetic field-assisted cathode sputtering (“magnetron sputtering”) and known to the person skilled in the art. The metal-based functional coating is usually deposited over the entire surface of the second pane intended to be an internal surface.

In a further embodiment of the method, the electrically conductive functional layer can be removed by means of laser decoating, mechanical decoating or removal of a masking attached during the application of the functional layer.

The invention further comprises the use of the vehicle glazing according to the invention in means of transport for traffic on land, in the air, or on water, in particular in trains, ships and motor vehicles, for example as a windscreen, panoramic windscreen and/or rear pane. The vehicle glazing is particularly preferably used in motor vehicles, most preferably as a windscreen. Furthermore, the invention comprises a vehicle having the vehicle glazing according to the invention.

All the standards mentioned relate to their version valid on the filing date.

The various embodiments of the invention may be implemented individually or in any combinations. In particular, the features mentioned above and to be explained below can be used not only in the specified combinations but also in other combinations or alone without departing from the scope of the invention. Unless exemplary embodiments and/or their features are explicitly mentioned only as alternatives or exclude one another.

The drawings are simplified schematic representations and are not true to scale. The drawings do not limit the invention in any way.

### Shown are:

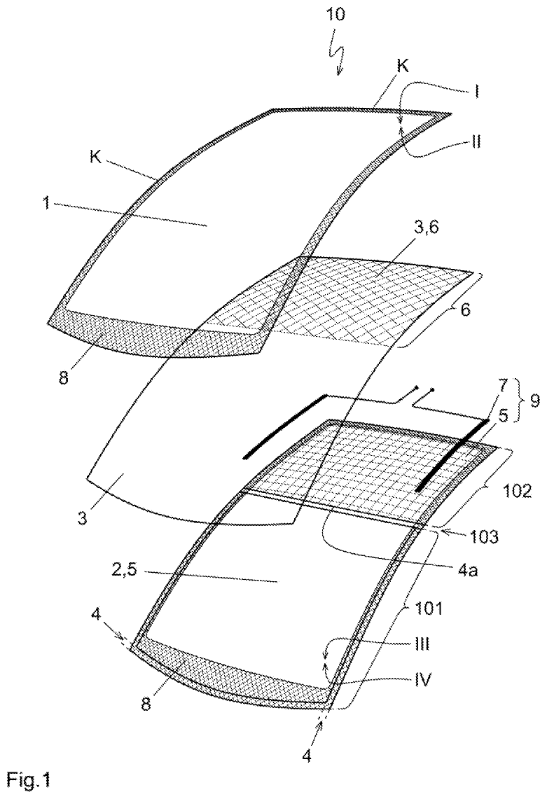

FIG. 1 an exploded view of a vehicle glazing according to the invention,

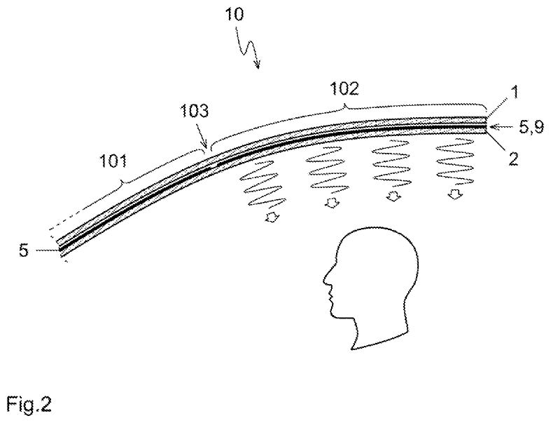

FIG. 2 a side view of an embodiment of the vehicle glazing according to the invention in the installation position, and

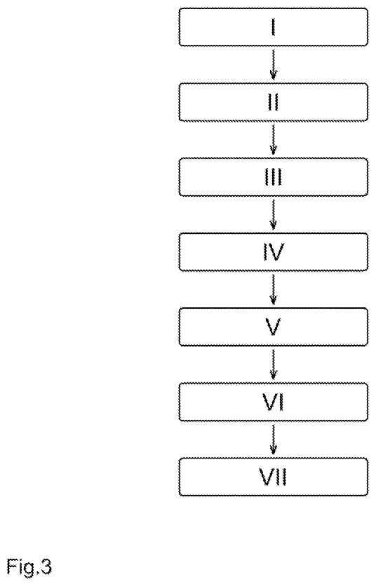

FIG. 3 a flowchart of an embodiment of a method according to the invention.

Data with numerical values are generally not to be understood as exact values, but also include a tolerance of +/−1% up to +/−10%.

FIG. 1 shows an embodiment of the vehicle glazing 10 according to the invention as a windscreen, in particular a panoramic windscreen. The vehicle glazing 10 is designed as a so-called panoramic windscreen, i.e. vehicles having such a panoramic windscreen have a panoramic windscreen extending up to the head area of the driver or even further in the direction toward the rear end of the vehicle.

The vehicle glazing 10 has a first pane 1 having an internal surface II and an external surface I and a circumferential side edge K. The vehicle glazing 10 also comprises a second pane 2 having an internal surface III and an external surface IV and a circumferential side edge K. The first pane 1 is connected to the second pane 2 via a thermoplastic intermediate layer 3. The internal surface II of the first pane 1 and the internal surface III of the second pane 2 face the thermoplastic intermediate layer 3.

The first pane 1 contains soda-lime glass, for example, and has a thickness of 2.1 mm. The second pane contains soda-lime glass, for example, and has a thickness of 1.6 mm. The thermoplastic intermediate layer 3 can, for example, be formed from a 0.76 mm thick PVB film.

The first pane 1 preferably represents the outer pane and the second pane 2 represents the inner pane of the vehicle glazing 10 formed as a composite pane. The vehicle glazing 10 further has a first area 101, an electrically heatable second area of the vehicle glazing 102 and a third area 103. The second area 102 has a heating element 9, which comprises two bus bars 7 and an electrically conductive functional layer 5. When an electrical voltage is applied to the bus bars 7, a heating current flows through the electrically conductive functional layer 5. For the electrical contacting of the electrically conductive functional layer 5, two bus bars 7 are provided, which are arranged such that a current flows through the electrically conductive functional layer 5 when an electrical voltage is applied to the bus bars 7.

A bus bar 7 is arranged on the left edge area of the electrically conductive functional layer 5. A second bus bar 7 is arranged on the right edge area of the electrically conductive functional layer in the second area 102. The bus bars 7 contain silver particles. They were applied by screen printing methods to the electrically conductive functional layer 5 and subsequently baked on. The length of the bus bars 7 approximately corresponds to the edge length of the area 102. If an electrical voltage is applied to the bus bars 7, a uniform electrical heating current flows through the electrically conductive functional layer 5. The second area 102 of the vehicle glazing 10 is heated by the heating current. Each bus bar 7 can in each case be electrically conductively connected to a foil conductor, which connects the bus bars 7 to an electrical voltage source.

An electrically conductive functional layer 5 is arranged on the internal surface III of the second pane 2. The electrically conductive functional layer 5 is a coating reflecting IR radiation and having three conductive silver layers and dielectric layers arranged in between. The electrically conductive functional layer has a total thickness of approximately 280 nm to 310 nm. The electrically conductive functional layer 5 is arranged on the entire internal surface III of the second pane 2 with the exception of a coating-free edge area 4 and an insulation line 4a (third area 103). The insulation line 4a is arranged in the third area 103 of the vehicle glazing 10 and separates the electrically conductive functional layer 5 into two sub-areas.

The first sub-area of the functional layer 5 is arranged in the first area 101 of the vehicle glazing 10. The second sub-area of the electrically conductive functional layer 5 is arranged in the second area 102 of the vehicle glazing 10. The electrically conductive functional layer 5 is removed or not applied in the coating-free edge area 4 and in the area of the insulation line 4a. This edge area 4 ensures that corrosion of the electrically conductive functional layer 5 does not occur. The width of the coating-free edge area 4 is measured from the side edge K of the second pane 2 and is 8 mm, for example.

The insulation line 4a ensures that the electrically conductive functional layer 5 in the first area 101 is not electrically conductively connected to the electrically conductive functional layer 5 in the second area 102.

The thermoplastic intermediate layer 3 has a coloured or tinted area 6, which extends in the second area 102 of the vehicle glazing 10. It contains no admixed colour pigments in this area. The coloured or tinted area 6 of the thermoplastic intermediate layer 3 is coloured blue-green or grey and has a linear colour gradient. This means that the coloured area 6 is variably coloured, wherein the light transmission increases linearly from the side edge K toward the centre of the pane. This leads to an optically attractive transition to the transparent area of the intermediate layer 3. However, the thermoplastic intermediate layer 3 in the first area 101 of the vehicle glazing 10 is transparent.

The vehicle glazing 10 designed as a windscreen has a circumferential peripheral cover print 8 which is formed (facing the interior of the vehicle in the installation position) by an opaque enamel on the internal surface II of the first pane 1 facing the intermediate layer 3. Optionally, the cover print 8 can also be applied to the external surface of the second pane 2 facing away from the intermediate layer 3.

FIG. 2 shows a side view of an embodiment of the vehicle glazing 10 according to the invention as a panoramic windscreen in the installation position. The vehicle glazing 10 is substantially the same as shown in FIG. 1. FIG. 2 illustrates the functionality of the second area 102 of the vehicle glazing 10. The heating element 9 emits heat and heats the intermediate space in the head area of the occupant.

Surprisingly, it has been found that such a vehicle glazing 10 according to the invention achieves significantly improved heating performance and a pleasant warm feeling of well-being in the occupants compared to the previously known windscreens.

FIG. 3 shows a flowchart of an exemplary embodiment of the method according to the invention for producing the vehicle glazing 10. The method comprises the following steps:
I. Initially, a first pane 1 is provided, which has a surface I intended to be an external surface and a surface II intended to be an internal surface and a circumferential side edge K. In addition, a second pane 2 is provided, which has a surface intended to be an external surface IV and a surface intended to be an internal surface III and a circumferential side edge K.
II. Then, an electrically conductive functional layer 5 is deposited over the entire surface III of the first pane 2, which is intended to be an internal surface, by means of magnetic field-assisted cathode deposition. For example, the electrically conductive functional layer 5 is a sun protection coating that reflects IR radiation and comprises the three silver layers and at least four dielectric layers.
III. A coating-free edge area 4 and an insulation line 4a are created either by masking during the deposition process or, for example, by laser decoating after the deposition process.
IV. Applying two bus bars 7 in the second area 102, which electrically contact the electrically conductive functional layer 5 such that a current flows through the electrically conductive functional layer 5 when an electrical voltage is applied to the bus bars 7.
V. Providing a thermoplastic intermediate layer 3 having a coloured area 6, which is at least as large as the second area 102.
VI. The first pane 1, the thermoplastic intermediate layer 3, and the second pane 2 are stacked flat one above the other such that the internal surface Ill of the second pane 2 points toward the thermoplastic intermediate layer 3 and the coloured area 6 is arranged congruent with the second area 102.
VII. In a last step, the coated first pane 1 is connected via the thermoplastic intermediate layer 3 to the second pane 2, for example in an autoclave method, and laminated.

### LIST OF REFERENCE SIGNS

1 first pane
2 second pane
3 intermediate layer
4 coating-free edge area
4a insulation line
5 electrically conductive functional layer
6 coloured area of the intermediate layer
7 bus bar
8 cover print
9 heating element
10 vehicle glazing
101 first area
102 second area
103 third area
K side edge of the first or second pane
I external surface of the first pane 1 facing away from the intermediate layer 3
II internal surface of the first pane 1 facing the intermediate layer 3
III internal surface of the second pane 2 facing the intermediate layer 3
IV external surface of the second pane 2 facing away from the intermediate layer 3

1-15. (canceled)

16. A vehicle glazing, comprising:
a first pane and a second pane connected via a thermoplastic intermediate layer,
an electrically conductive functional layer arranged on an internal surface of the second pane facing the thermoplastic intermediate layer,
a first area of the second pane, and
a second area of the second pane, the second area being electrically heatable,
wherein:
the first area is a test area with a central field of vision,
the second area is a roof area with a curvature,
the second area has a heating element comprising two bus bars and at least a portion of the electrically conductive functional layer, such that a current flows through the electrically conductive functional layer when an electrical voltage is applied to the two bus bars, and
the first area is electrically insulted from the second area by a third area.

17. The vehicle glazing according to claim 16, wherein the vehicle glazing is a panoramic pane.

18. The vehicle glazing according to claim 16, wherein the second area is arranged in an upper sub-area of the vehicle glazing.

19. The vehicle glazing according to claim 16, wherein the electrically conductive functional layer is transparent.

20. The vehicle glazing according to claim 16, wherein the bus bars extend substantially in a longitudinal direction of the vehicle glazing.

21. The vehicle glazing according to claim 16, wherein the electrically conductive functional layer contains at least one metallic layer.

22. The vehicle glazing according to claim 21, wherein the at least one metallic layer is a silver layer.

23. The vehicle glazing according to claim 16, wherein the first area comprises at least a portion of the electrically conductive functional layer, and the portion of the electrically conductive functional layer in the first area reflects light in an infrared range.

24. The vehicle glazing according to claim 16, wherein the third area is an insulation line.

25. The vehicle glazing according to claim 16, wherein the third area is arranged orthogonally between two side edges of the vehicle glazing.

26. The vehicle glazing according to claim 16, wherein the third area has a width of 5 μm to 500 μm.

27. The vehicle glazing according to claim 26, wherein the third area has a width of 20 μm to 200 μm.

28. The vehicle glazing according to claim 16, wherein the intermediate layer has a tinted or coloured area.

29. The vehicle glazing according to claim 16, wherein at least one of the first pane and the second pane has an opaque cover print in an edge area of the vehicle glazing.

30. A method for producing a vehicle glazing comprising the steps of:
providing a first pane and a second pane, the second pane having a first area and a second area,
applying an electrically conductive functional layer to an internal surface of the second pane,
removing a portion of the electrically conductive functional layer to form a third area of the second pane, the third area electrically insulating the first area from the second area,
applying two bus bars within the second area, which electrically contact the electrically conductive functional layer such that a current flows through the electrically conductive functional layer within the second area when an electrical voltage is applied to the two bus bars,
providing a thermoplastic intermediate layer having a tinted and/or coloured area, the thermoplastic intermediate layer being at least as large as the second area,
forming a stack of the first pane, the second pane and the thermoplastic intermediate layer in between, such that the internal surface of the second pane faces the thermoplastic intermediate layer, and the tinted and/or coloured area of the intermediate layer covers the second area,
connecting the first pane, the second pane and the thermoplastic intermediate layer under an action of at least one of: heat, vacuum and pressure.

31. The method according to claim 30, wherein the electrically conductive functional layer is removed by means of laser decoating, mechanical decoating or removal of a masking attached during application of the electrically conductive functional layer.

32. A vehicle comprising the vehicle glazing according to claim 16, the vehicle being a transport for traffic on land, in air, or on water.

33. The vehicle according to claim 32, wherein the vehicle is selected from the group consisting of a train, a ship, or a motor vehicle.

34. The vehicle according to claim 32, wherein the vehicle glazing is a windscreen or a rear pane.
